(19) United States
(12) Patent Application Publication
(10) Pub. No.: US 2016/0308786 A1
(43) Pub. Date: Oct. 20, 2016

(54) Temporal Tunnel Services

(71) Applicant: Futurewei Technologies, Inc., Plano, TX (US)

(72) Inventors: Huaimo Chen, Bolton, MA (US); Renwei Li, Sunnyvale, CA (US)

(21) Appl. No.: 15/083,922

(22) Filed: Mar. 29, 2016

Related U.S. Application Data
(60) Provisional application No. 62/149,059, filed on Apr. 17, 2015.

(51) Int. Cl. H04L 12/911; H04L 12/913; H04L 12/803

(52) U.S. Cl. CPC H04L 47/825; H04L 47/826; H04L 47/125; H04L 47/748; H04L 47/724

(57) ABSTRACT

An ingress node in a network, comprising a receiver configured to receive a first request for a temporal label switched path (LSP) in the network, wherein the first request indicates a network constraint and a scheduled time interval having a predetermined start time and a predetermined end time for the temporal LSP to carry traffic, a processor coupled to the receiver and configured to compute a path in the network for the temporal LSP, wherein the path satisfies the network constraint in the scheduled time interval, and reserve a network resource for use during the scheduled time interval for the temporal LSP in advance of the predetermined start time, and a transmitter coupled to the processor and configured to send a path request message to the next hop node to initiate set up of the temporal LSP in the network.

### CROSS-REFERENCE TO RELATED APPLICATIONS

The present application claims priority to U.S. Provisional Patent Application 62/149,059, filed Apr. 17, 2015 by Huaimo Chen and Renwei Li, and entitled “Temporal Tunnel Services.” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Multiprotocol label switching (MPLS) is a data-carrying mechanism that directs data from one network node to a next network node based on path labels instead of network addresses, avoiding complex lookups in a routing table. The path labels identify virtual links or paths between distant nodes, rather than endpoints. MPLS may be used to carry different kinds of traffic, including Internet protocol (IP) packets, asynchronous transfer mode (ATM) frames, synchronous optical networking (SONET) frames, and Ethernet frames.

### SUMMARY

In one embodiment, the disclosures includes an ingress node in a network, comprising a receiver configured to receive a first request for a temporal label switched path (LSP) in the network, wherein the first request indicates a network constraint and a scheduled time interval having a predetermined start time and a predetermined end time for the temporal LSP to carry traffic, a processor coupled to the receiver and configured to compute a path in the network for the temporal LSP, wherein the path satisfies the network constraint in the scheduled time interval, and reserve a network resource for use during the scheduled time interval for the temporal LSP in advance of the predetermined start time, wherein the network resource is reserved on a link extending from the ingress node to a next hop node on the path, and a transmitter coupled to the processor and configured to send a path request message to the next hop node to initiate set up of the temporal LSP in the network. In some embodiments, the disclosure also includes wherein reserving the network resource does not include a reservation for the network resource at a current time, and wherein the network resource is reserved from a time-based traffic engineering link state database (TEDB), and/or wherein the scheduled time interval is a recurrent time interval, and wherein the path request message further indicates a repeat period that the scheduled time interval repeats and a number of repeats for the scheduled time interval, and/or wherein the first request further indicates a desired start time and an elastic time range for the scheduled time interval, wherein the processor is further configured to compute the path for the temporal LSP by determining a minimum amount of time to shift the scheduled time interval from the desired start time such that the shifted scheduled time interval satisfies the network constraint and is temporally positioned within the elastic time range, and wherein the path request message indicates the shifted scheduled time interval, and/or wherein the transmitter is further configured to distribute, in the network, an update of remaining available network resources on the link in the scheduled time interval after the network resource is reserved on the link, and/or wherein the receiver is further configured to receive a reserve request message from the next hop node subsequent to sending the path request message, wherein the reserve request message requests an in-advance reservation of the network resource for the temporal LSP from the predetermined start time to the predetermined end time, and wherein the network resource is reserved in response to the reserve request message, and/or wherein the receiver is further configured to receive a second request to tear down the temporal LSP, wherein the processor is further configured to release the network resource reserved in advance on the link in remaining time of the scheduled time interval, and wherein the transmitter is further configured to send a path tear down message to the next hop node to initiate the tear down of the temporal LSP in the network, and/or wherein the network constraint comprises a bandwidth constraint, a priority constraint, a number of hops constraint, a wavelength constraint, or combinations thereof.

In another embodiment, the disclosure includes a method implemented in a network element (NE), comprising receiving, via a receiver of the NE, a first path request message requesting creation of a first temporal label switched path (LSP) in a network, wherein the first path request message indicates a first network constraint, a first path, and a first scheduled time interval having a predetermined start time and a predetermined end time for the first temporal LSP to carry first traffic, determining, via a processor of the NE, that a first next hop link from the NE to a first next downstream node on the first path comprises a sufficient amount of first network resource in the first scheduled time interval to satisfy the first network constraint, and reserving, via the processor, the first network resource on the first next hop link for use during the first scheduled time interval for the first temporal LSP in advance of the predetermined start time according to the first network constraint to facilitate data forwarding for the first temporal LSP in the first scheduled time interval. In some embodiments, the disclosure also includes generating, via the processor, a second path request message according to the first path request message to indicate the first scheduled time interval, sending, via a transmitter of the NE, the second path request message to the first next downstream node to request the creation of the first temporal LSP in the network in the first scheduled time interval, and/or wherein the NE is an ingress node of the first temporal LSP, and wherein the method further comprises receiving, via the receiver, a configuration for the first temporal LSP indicating the first scheduled time interval and the first network constraint, computing, via the processor, the first path for the first temporal LSP satisfying the first network constraint in the first scheduled time interval, generating, via the processor, the first path request message according to the first path computed for the first temporal LSP and the first scheduled time interval received in the configuration, and sending, via the transmitter, the first path request message to the NE, and/or storing, in a memory of the NE, information associated with the first path, the first network constraint, and the first scheduled time interval of the first temporal LSP received in the first path request message, and receiving, via the receiver, a reserve request message from the first next downstream node requesting in-advance reservation of the first network resource, and wherein the first network resource is reserved in advance on the first next hop link according to the information stored in the memory in response to the reserve request message received, and/or storing, in a memory of the NE, a time-based traffic engineering link state database (TEDB), wherein the first network resource is reserved in advance on the first next hop link from the time-based TEDB, and/or receiving, via the receiver, a path tear down message requesting deletion of the first temporal LSP, and releasing, via the processor, the first network resource reserved in advance on the first next hop link in remaining time of the first scheduled time interval, and/or receiving, via the receiver, a third path request message from a next upstream node requesting creation of a second temporal LSP in the network, wherein the second path request message indicates a second network constraint, a second path, and a second scheduled time interval for the second temporal LSP to carry second traffic, determining, via the processor, that a second next hop link to a second next downstream node on the second path comprises an insufficient amount of second network resource in the second scheduled time interval to satisfy the second network constraint, and sending, via the transmitter, a path error message to the next upstream node indicating a creation error status for the second temporal LSP.

In another embodiment, the disclosure includes a method comprising receiving, by an ingress node of a temporal LSP in a network, a configuration for the temporal LSP with a time interval, computing, by the ingress node, a path in the network satisfying a constraint for the temporal LSP in the time interval, reserving, by the ingress node, a bandwidth on a link to a next hop node on the path in the time interval, and setting up, by the ingress node, the temporal LSP in the network to carry traffic in the time interval. In some embodiments, the disclosure also includes wherein setting up the temporal LSP in the network further comprises sending, by the ingress node to a next hop node on the path, a resource reservation protocol-traffic engineering (RSVP-TE) path message comprising a time-interval object, wherein the time-interval object comprises a Start-Time field indicating a first time that the temporal LSP starts to carry traffic, and an End-Time field indicating a second time that the temporal LSP ends carrying the traffic, and wherein the first time and the second time are clock times that are synchronized among all network nodes in the network, and/or wherein the time interval is a recurrent time interval that the LSP carries the traffic, and wherein the time-interval object further comprises a Number-repeats field indicating a number of repeats, a Repeat-time-length field indicating a repeat-time length in seconds of a repeat cycle for the recurrent time interval, and an Options field indicating whether the recurrent time interval repeats every day, every week, every month, every year, or repeats every repeat-time length, and/or wherein setting up the LSP in the network further comprises sending, by the ingress node to a next hop node on the path, a RSVP-TE path message comprising a time-interval object, and wherein the time-interval object comprises a Start-time-length field indicating a first time length in seconds from a current local clock time to a first time that the LSP starts to carry traffic, and an End-time-length field indicating an second time length in seconds from the current local clock time to a second time that the LSP ends carrying the traffic, and/or wherein the time interval is a recurrent time interval that the LSP carries the traffic, and wherein the time-interval object further comprises a Number-repeats field indicating a number of repeats, a Repeat-time-length field indicating a repeat-time length in seconds of a repeat cycle for the recurrent time interval, and an Options field indicating whether the recurrent time interval repeats every day, every week, every month, every year, or repeats every repeat-time length.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description wherein like reference numerals represent like parts.

FIG. 1 is a schematic diagram of an embodiment of a MPLS network that provides temporal tunnel services.

FIG. 2 is a schematic diagram of an embodiment of a NE.

FIG. 3 is a timing diagram of an embodiment of a temporal bandwidth reservation scheme.

FIG. 4 is a timing diagram of an embodiment of a temporal bandwidth reservation scheme with a recurrent time interval.

FIG. 5 is a timing diagram of an embodiment of a temporal bandwidth reservation scheme with an elastic time interval.

FIG. 6 is a protocol diagram of an embodiment of a method of creating a temporal LSP tunnel.

FIG. 7 is a protocol diagram of an embodiment of a method of deleting a temporal LSP tunnel.

FIG. 8 is a flowchart of an embodiment of a method of creating a temporal LSP.

FIG. 9 is a flowchart of another embodiment of a method of creating a temporal LSP.

FIG. 10 is a flowchart of another embodiment of a method of creating a temporal LSP.

FIG. 11 is a flowchart of an embodiment of a method of deleting a temporal LSP.

FIG. 12 is a schematic diagram illustrating an embodiment of an absolute time interval object.

FIG. 13 is a schematic diagram illustrating an embodiment of a relative time interval object.

FIG. 14 is a schematic diagram illustrating an embodiment of a combined time interval object.

FIG. 15 is a schematic diagram illustrating an embodiment of a recurrent absolute time interval object.

FIG. 16 is a schematic diagram illustrating an embodiment of a recurrent combined time interval object.

FIG. 17 is a schematic diagram illustrating an embodiment of a recurrent relative time interval object.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalent.

MPLS traffic engineering (MPLS TE) integrates traffic engineering (TE) capabilities into open system interconnection (OSI) model layer 3 (L3), which optimizes the routing of IP traffic, given the constraints imposed by backbone network capacity and topology. In a MPLS TE network, packets are mapped to traffic flows, forwarding paths are computed based on the traffic flow's resource requirement and available network resource, and traffic flows are transported across the network using MPLS forwarding. Examples of a traffic flow's resource requirement may include bandwidth requirements, latency tolerances, a priority versus other traffic flows, and a limit on the number of hops. In MPLS forwarding, paths are predetermined and established for particular source-destination pairs instead of forwarded on a hop-by-hop basis. The predetermined paths are referred to as LSPs or tunnels.

Although MPLS TE enables the establishment of resource-guaranteed end-to-end LSPs or tunnels. MPLS TE LSP tunnels are not time-aware. Once an existing MPLS TE LSP tunnel is set up, the MPLS TE LSP tunnel is assumed to carry traffic indefinitely until the MPLS TE LSP tunnel is down, for example, initiated by a tear down command or caused by a link and/or node fault. When an MPLS TE LSP tunnel is established, it is assumed that the tunnel consumes its reserved network resources even though the tunnel may only use the reserved network resources for a period of time. As a result, tunnel service may not be scheduled in advance.

Disclosed herein are various embodiments for establishing temporal LSP tunnels. A temporal LSP tunnel is a tunnel that is scheduled for carrying traffic in one or more predetermined time intervals. For example, many tunnel services are planned and scheduled. The disclosed embodiments provide mechanisms for reserving network resources for temporal tunnels during certain time intervals in advance. Thus, the disclosed embodiments enable efficient usage of network resources and allow internet service providers (ISPs) to provide service scheduling and/or service calendaring. In an embodiment, a network administrator or a user configures an ingress node of a temporal LSP with a time schedule and a network constraint for the temporal LSP to carry traffic. A time schedule may comprise one or more pre-determined time intervals each comprising a definite duration. The ingress node computes a shortest path in the network for the temporal LSP satisfying the network constraint in each time interval. The ingress node initiates the creation of the temporal LSP in a downstream direction. For example, a path request message is forwarded to each node on the path. Each node checks the availability of network resources in the each time interval. When the path message reaches an egress node of the temporal LSP, the egress node initiates an in-advance reservation of network resource for the temporal LSP in an upstream direction. For example, a reserve request message is forwarded to each node on the path. Each node reserves network resource in advance for the temporal LSP in each time interval on a next hop link to a next downstream node on the path. Downstream refers to the direction from a source to a destination, whereas upstream refers to the direction from a destination to a source. To tear down the temporal LSP, the network administrator or the user sends the ingress node a request. The ingress node initiates the tear down of the temporal LSP in a downstream direction, where a path teardown message is forwarded to each node on the path. Each node releases the in advance reserved network resource in remaining time intervals that have not elapsed. Although the disclosed embodiments describe the in advance resource reservation mechanism in the context of bandwidths, the disclosed embodiments are may be applied to reserve any network resource in advance.

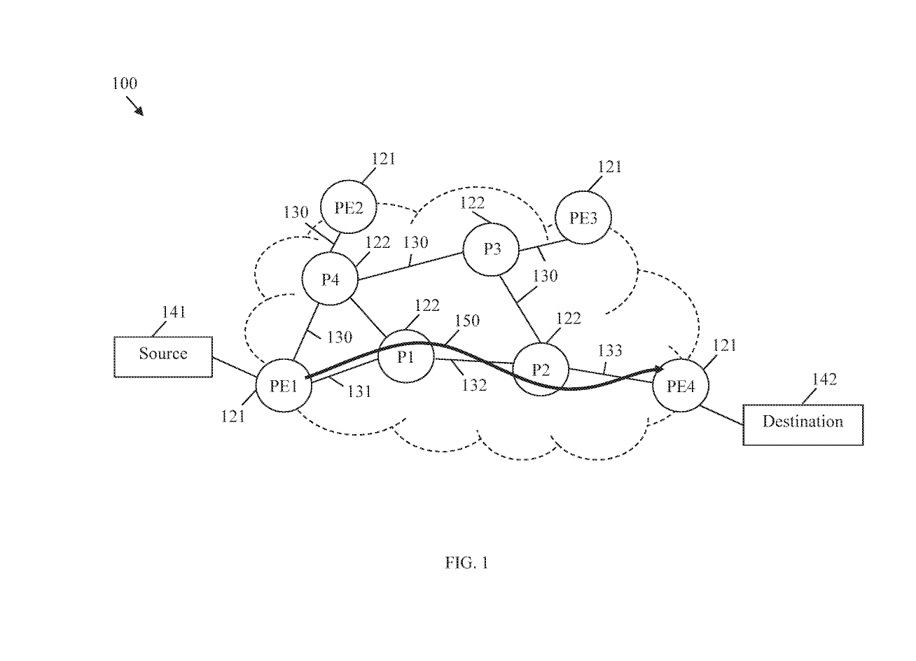

FIG. 1 is a schematic diagram of an embodiment of a MPLS network 100 that provides temporal tunnel services. The network 100 comprises a plurality of edge nodes 121 and a plurality of internal nodes 122 interconnected by a plurality of communication links 130, 131, 132, and 133. The edge nodes 121 are shown as PE1, PE2, PE2, and PE4. The edge nodes 121 are located at an edge or a boundary of the network 100 and may be coupled to one or more nodes that are located outside the network 100. The internal nodes 122 are shown as P1, P2, P3, and P4. The internal nodes 122 are located within the network 100. The underlying physical network of the network 100 may be any type of transport network such as an electrical network and/or an optical network. The communication links 130-133 may comprise physical links such as fiber optic links, electrical links, wireless links and/or logical links used to transport data in the network 100. The network 100 may operate under a single network administrative domain or multiple network administrative domains. The network 100 employs a MPLS forwarding data plane.

The edge nodes 121 and the internal nodes 122 are network devices configured to perform temporal tunnel service operations in the network 100. Some example temporal tunnel service operations include computing paths for temporal LSPs, reserving resources on the links 130-133 that are along the computed paths in advance, setting up the temporal LSPs, and tearing down the temporal LSPs. A LSP is a predetermined route between a source-destination pair and identified by path labels. A temporal LSP is a scheduled LSP, where network resources are reserved in advance for links 130-133 along a path of the temporal LSP according to scheduled time intervals instead of an indefinite time interval.

As an example, the network 100 is configured with a temporal LSP 150 that is scheduled to transport data traffic for a data flow between a source 141 and a destination 142 according to a given time schedule. The source 141 is any network device configured to generate data for the data flow. The destination 142 is any network device configured to consume the data of the data flow. The temporal LSP 150 extends from the edge node PE1 121 to the edge node PE4 121, traversing through the internal nodes P1 and P2 122. The edge node PE1 121 that receives data traffic from the source 141 external to the network 100 and sends data traffic using the temporal LSP 150 in the network 100 is referred to as an ingress node of the LSP. The edge node PE4 121 that receives data traffic from the LSP 150 in the network 100 and sends data traffic to the destination 142 outside of the network 100 is referred to as an egress node of the LSP. The internal nodes P1 and P2 122 located along a path of the temporal LSP 150 between the ingress node and the egress node are referred to as transit nodes of the LSP.

In an embodiment, a network administrator or a user configures the edge node PE1 121, which is the ingress node of the temporal LSP 150, with a time schedule and a network constraint. The time schedule comprises one or more time intervals scheduled for the temporal LSP 150 to carry traffic. The edge node PE1 121 computes a shortest path in the network for the temporal LSP 150 satisfying the network constraint in each time interval. The edge node PE1 121 initiates the creation of the temporal LSP 150 in a downstream direction. For example, a path request message is forwarded to each node, which includes the internal nodes P1 and P2 122 and the edge node PE4 121, on the path. Each node checks the availability of a network resource on a next hop link in each time interval. For example, the edge node PE1 121 checks network resource availability on the link 131, the internal node P1 122 checks network resource availability on the link 132, and the internal node P2 122 checks network resource availability on the link 133. When the path message reaches the edge node PE4 121, which is the egress node of the temporal LSP 150, the edge node PE4 121 initiates an in-advance reservation of network resources for the temporal LSP 150 in an upstream direction. For example, a reserve request message is forwarded to each node on the path, including the internal nodes P1 and P2 122 and the edge node PE1 121. Each node reserves network resource in advance for the temporal LSP 150 in each time interval on a next hop link to a next downstream node on the path.

To tear down the temporal LSP 150, the network administrator or the user sends the edge node PE1 121 a request. The edge node PE1 121 initiates the tear down of the temporal LSP 150 in a downstream direction, where a path teardown message is forwarded to each node on the path. Each node releases the in advance reserved network resource in remaining time intervals that have not elapsed. The configurations of time schedules and the mechanisms of temporal LSP creation and deletion are described more fully below.

In an embodiment, the edge nodes 121 and the internal nodes 122 implement RSVP-TE protocols as described in Internet Engineering Task Force (IETF) Request For Comments (RFC) 3209 titled. “RSVP-TE: Extensions to RSVP for LSP Tunnels,” published in December 2001 by D. Awduche, et al., and RFC 4875 titled, “Extensions to Resource Reservation Protocol-Traffic Engineering (RSVP-TE) for Point-to-Multipoint TE Label Switched Paths (LSPs),” published in May 2007 by R. Aggarwal, et al., respectively, which are incorporated by reference. In such an embodiment, the path request message may be similar to the RSVP path (PATH) message described in RFC 3209, but may be extended to include a LSP time schedule. The reserve request message may be similar to the RSVP reserve (RESV) message. It should be noted that the network 100 may be configured as shown or alternatively configured as determined by a person of ordinary skill in the art to achieve similar functionalities.

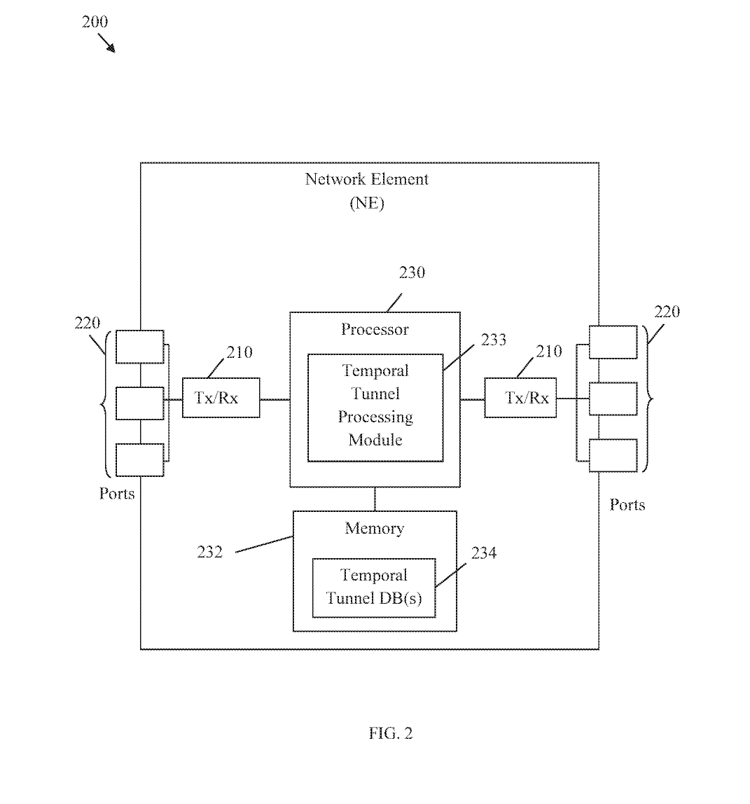

FIG. 2 is a schematic diagram of an embodiment of a NE 200, such as edge nodes 121, the internal nodes 122, the source 141, or the destination 142 in a network such as the network 100. NE 200 may be configured to implement and/or support temporal tunnel creation and deletion mechanisms and schemes described herein. NE 200 may be implemented in a single node or the functionality of NE 200 may be implemented in a plurality of nodes. One skilled in the art will recognize that the term NE encompasses a broad range of devices of which NE 200 is merely an example. NE 200 is included for purposes of clarity of discussion, but is in no way meant to limit the application of the present disclosure to a particular NE embodiment or class of NE embodiments.

At least some of the features/methods described in the disclosure are implemented in a network apparatus or component such as an NE 200. For instance, the features/methods in the disclosure may be implemented using hardware, firmware, and/or software installed to run on hardware. The NE 200 is any device that transports packets through a network, e.g., a switch, router, bridge, server, a client, etc. As shown in FIG. 2, the NE 200 comprises transceivers (Tx/Rx) 210, which may be transmitters, receivers, or combinations thereof. The Tx/Rx 210 is coupled to a plurality of ports 220 for transmitting and/or receiving frames from other nodes.

A processor 230 is coupled to each Tx/Rx 210 to process the frames and/or determine which nodes to send the frames to. The processor 230 may comprise one or more multi-core processors and/or memory devices 232, which may function as data stores, buffers, etc. The processor 230 may be implemented as a general processor or may be part of one or more application specific integrated circuits (ASICs) and/or digital signal processors (DSPs).

The processor 230 comprises a temporal tunnel processing module 233, which may perform path computation, in advance network resource reservation, creation and deletion of temporal LSPs such as the temporal LSPs 150 depending on the embodiments and may implement methods 600, 700, 800, 900, 1000, and 1100, as discussed more fully below, and/or any other flowcharts, schemes, and methods discussed herein. As such, the inclusion of the temporal tunnel processing module 233 and associated methods and systems provide improvements to the functionality of the NE 200. Further, the temporal tunnel processing module 233 effects a transformation of a particular article (e.g., the network) to a different state. In an alternative embodiment, the temporal tunnel processing module 233 may be implemented as instructions stored in the memory devices 232, which may be executed by the processor 230.

The memory device 232 may comprise a cache for temporarily storing content, e.g., a random-access memory (RAM). Additionally, the memory device 232 may comprise a long-term storage for storing content relatively longer, e.g., a read-only memory (ROM). For instance, the cache and the long-term storage may include dynamic RAMs (DRAMs), solid-state drives (SSDs), hard disks, or combinations thereof. The memory device 232 may be configured to store one or more temporal tunnel databases (DBs) 234, which may include a forwarding information base (FIB), a time-based traffic engineering (TE) DB, and/or a LSP DB, as discussed more fully below.

It is understood that by programming and/or loading executable instructions onto the NE 200, at least one of the processor 230 and/or memory device 232 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions (e.g., a computer program product stored in a non-transitory medium/memory) may be viewed as a particular machine or apparatus.

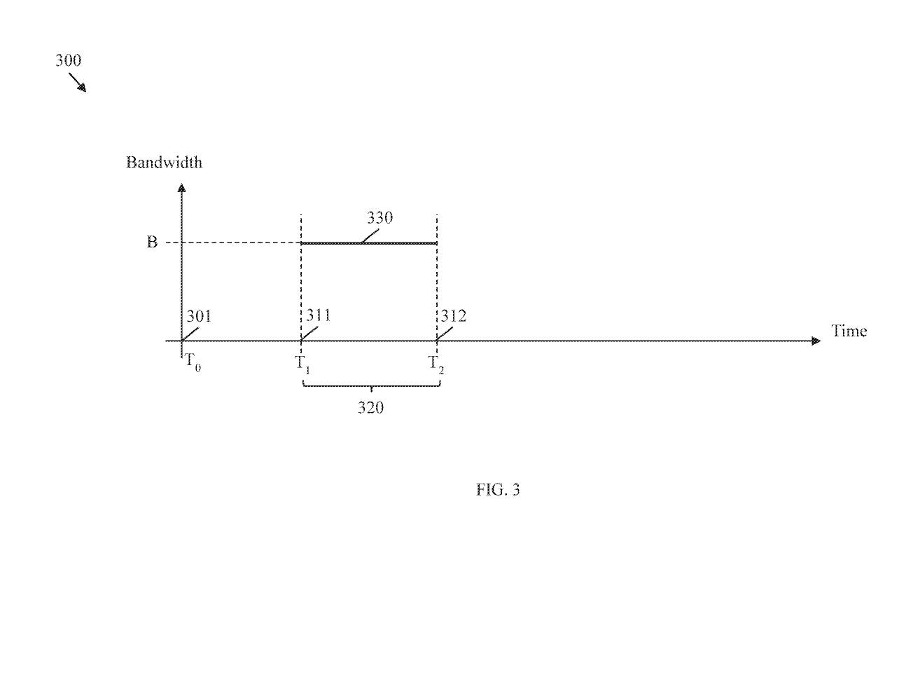

FIG. 3 is a timing diagram of an embodiment of a temporal bandwidth reservation scheme 300. The x-axis represents time in some arbitrary units of time and the y-axis represents bandwidth in some arbitrary units of bandwidth. The scheme 300 is employed by an ingress node such as the edge node PE1 121 and a transit node such as the internal nodes P1 and P2 122 along a path of a temporal LSP such as the temporal LSP 150 to reserve a bandwidth for the temporal LSP. The bandwidth is reserved in advance. For example, a temporal LSP is scheduled to carry traffic in a time interval 320 from a time 311, denoted as T₁, to a time 312, denoted as T₂, where the traffic requires a bandwidth 330 in an amount of B. A path for the temporal LSP is computed such that the path satisfies the bandwidth constraint and any other constraints in the time interval 320. The bandwidth 330 is reserved in advance at a time 301, denoted as T₀, prior to the start time T₁ of the scheduled time interval 320. The time schedule for the scheme 300 is represented as [T₁. T₂]. For example, a network administrator may configure a LSP time schedule that begins at 9 AM and ends at 11 AM. Alternatively, a network administrator may configure a LSP time schedule with a series of time schedules, for example, from 9 AM to 11 AM, from 12 PM to 1 PM, and from 3 PM to 9 PM. A path request message may include the time schedule by indicating an absolute time for the time 311, an absolute time for the time 312, a relative time for the time 311, a relative time for the time 312, a duration of the interval 320, or combinations thereof, as described more fully below.

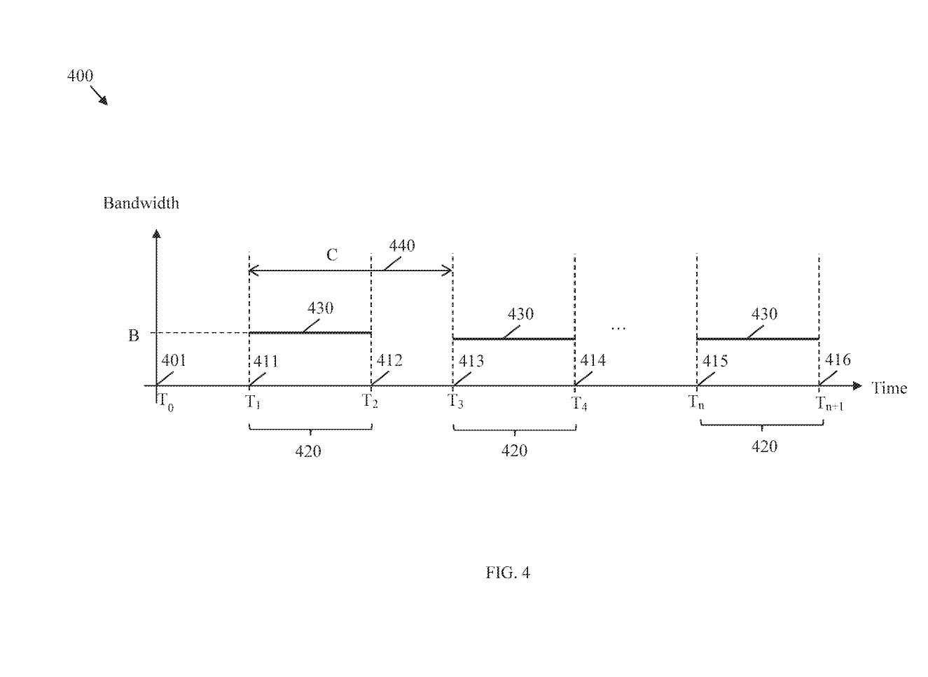

FIG. 4 is a timing diagram of an embodiment of a temporal bandwidth reservation scheme 400 with a recurrent time interval. The x-axis represents time in some arbitrary units of time and the y-axis represents bandwidth in some arbitrary units of bandwidth. The scheme 400 is employed by an ingress node such as the edge node PE1 121 and a transit node such as the internal nodes P1 and P2 122, along a path of a temporal LSP such as the temporal LSP 150 to reserve a bandwidth for the temporal LSP. The scheme 400 is similar to the scheme 300, but reserves a bandwidth repeatedly over a series of time intervals 420. For example, a temporal LSP is scheduled to carry traffic in a time interval 420 from a time 411, denoted as T₁, to a time 412, denoted as T₂, and repeats at a repeat cycle 440 with a duration of C after the temporal LSP starts to carry traffic, where the traffic requires a bandwidth 430 in an amount of B. A path for the temporal LSP is computed such that the path satisfies the bandwidth constraint and any other constraints in the time intervals 420. The bandwidth B is reserved in advance at a time 401, denoted as T₀, prior to the start time 411, T1, of the series of time intervals 420. As shown, a first of the time intervals 420 begins at the time 411 and ends at the time 412. A second of the time intervals 420 begins at a time 413, denoted as T₃, and ends at a time 414, denoted as T₄, where T₃=T₁+C. A last of the time intervals 420 begins at a time 415, denoted as Tₙ, and ends at a time 416, denoted as Tₙ₊₁, where Tₙ=Tₙ₋₂+C. Thus, a time schedule for the scheme 400 is represented as shown below:

[Tᵢ,Tᵢ₊₁].

where i=1, 3, 5, . . . , n, Tⱼ≦Tⱼ₊₁, j=1, 2, . . . . to n. Tⱼ₊₂=Tⱼ+C, and Tₙ₊₁ is the end of the schedule. For example, a network administrator may configure a LSP time schedule that repeats every day from 9 AM to 11 AM. A path request message may include the time schedule by indicating an absolute time for the time 411, an absolute time for the time 412, a relative time for the time 411, a relative time for the time 412, a duration of the interval 420, a duration of the repeat cycle 440, a number of repeats, or combinations thereof, as described more fully below.

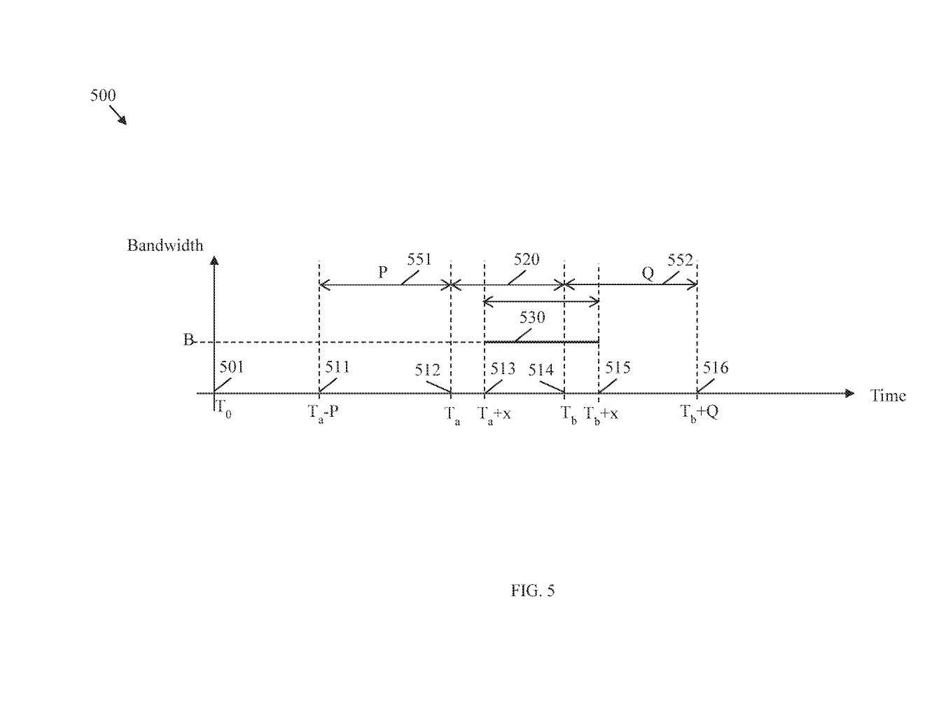

FIG. 5 is a timing diagram of an embodiment of a temporal bandwidth reservation scheme 500 with an elastic time range. The x-axis represents time in some arbitrary units of time and the y-axis represents bandwidth in some arbitrary units of bandwidth. The scheme 500 is employed by an ingress node such as the edge node PE1 121 and a transit node such as the internal nodes P1 and P2 122 along a path of a temporal LSP such as the temporal LSP 150 to reserve a bandwidth for the temporal LSP. The scheme 500 is similar to the scheme 300, but reserves bandwidth in a time interval 520 with an elastic range. For example, a temporal LSP is scheduled to carry traffic in a time interval 520 from a time 512, denoted as Tₐ, to a time 514, denoted as T_{b}, where the traffic requires a bandwidth 530 in an amount of B. However, the schedule may be shifted with an elastic range lower bound 551, denoted as P, and an elastic range upper bound 552, denoted as Q. Thus, a path for the temporal LSP is computed such that the path satisfies the bandwidth constraint and any other constraints in a time interval of 520, beginning at a time 511, denoted as Tₐ−P, or ending at a time 516, denoted as T_{b}+Q. As shown, a bandwidth 530 is reserved between a time 513, denoted as Tₐ+x, and ends at a time 515, denoted as T_{b}+X, where x satisfies the elastic range lower bound 551 and the elastic range upper bound 552. The bandwidth B is reserved in advance at a time 501, denoted as To, prior to the start time 513. Tₐ+x, of the time interval 520. A time schedule for the scheme 500 is represented as shown below:

[Tₐ+x,T_{b}+x],

where −P≦x≦Q and x represents a minimum amount of time from −P to Q that is required to shift requested time interval 520 in order to satisfy the requested constraints. For example, a network administrator may configure a LSP time schedule that starts at 9 AM and ends at 11 AM, but allows the LSP time schedule to be shifted with a time window between 8:45 AM and 11:15 AM. A path request message may include the time schedule by indicating an absolute time for the time 512, an absolute time for the time 514, a relative time for the time 512, a relative time for the time 514, a duration of the time interval 520, a duration of the elastic range lower bound 551, a duration of the elastic range upper bound 552, or combinations thereof, as described more fully below.

It should be noted that although the schemes 300, 400, and 500 illustrate scheduling mechanisms for bandwidth reservation, the schemes 300, 400, and 500 may be employed for reserving another suitable network resource such as wavelengths in advance according to a time schedule.

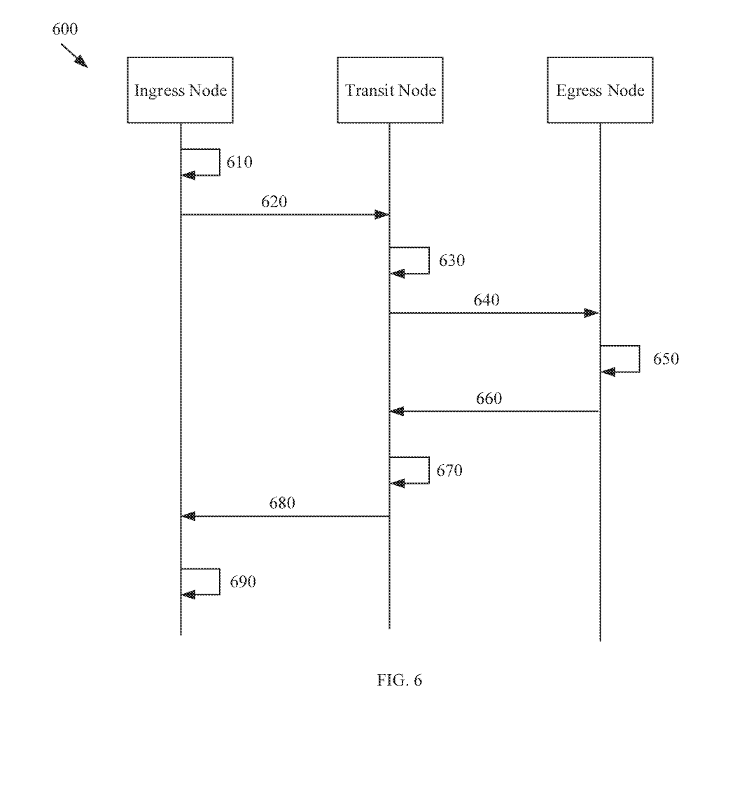

FIG. 6 is a protocol diagram of an embodiment of a method 600 of creating a temporal LSP such as the temporal LSP 150. The method 600 is implemented between an ingress node, a transit node, and an egress node of a temporal LSP in a network such as the network 100. The ingress node is similar to the edge node PE1 121, the transit node is similar to the internal node P1 and P2 122, and the egress node is similar to the edge node PE4 121. The method 600 is implemented when the ingress node receives a request for creating a temporal LSP to serve a data flow according to a given time schedule. The request may include a source such as the source 141 and a destination such as the destination 142 of the data flow, a path computation constraint such as bandwidth, and one or more upcoming time intervals when the temporal LSP is scheduled to carry data traffic for the data flow. The time intervals are similar to the time intervals 320, 420, and 520 and may additionally include an elastic range with a lower bound such as the elastic range lower bound 551 and an upper bound such as the elastic range upper bound 552. At step 610, the ingress node computes a shortest path for the temporal LSP satisfying the constraint in every time interval of the time schedule. For example, the shortest path traverses the ingress node, the transit node, and the egress node in order. After computing the shortest path, the ingress node generates a first path request message for creating the LSP. The first path request message indicates the shortest path, the constraint, and the time schedule for the LSP. For example, the shortest path indicates the transit node followed by the egress node. The first path request message is described more fully below. At step 620, the ingress node sends the first path request message to the transit node. In some embodiments, the ingress node also sends the first path request message to itself and the ingress node may perform similar operations as other transit nodes on the shortest path, as described more fully below in step 630. In such embodiments, the first path request message indicates a complete node sequence of the shortest path including the ingress node.

At step 630, upon receiving the first path request message, the transit node processes the first path request message to obtain the time schedule, the constraint, and a next hop node along the path of the temporal LSP, where the next hop node is the egress node. The transit node stores the information in the first path request message in memory such as the memory device 232. The transit node determines that a next hop link to the next hop node satisfies the constraints in every time interval of the time schedule. The transit node updates the first path request message to produce a second path request message. For example, the transit node updates the path in the first path request message by removing reference to the transit node itself. At step 640, the transit node sends the second path request message to the egress node.

At step 650, upon receiving the second path request message, the egress node allocates a first label for the temporal LSP, writes a forwarding entry for the LSP in a local FIB to facilitate subsequent data forwarding to the destination. The FIB may be stored in a memory device such as the memory device 232. The egress node generates a first reserve request message to request an in advance resource reservation on links along the path of the temporal LSP. The first reserve request message indicates the first label. At step 660, the egress node sends the first reserve request message to the transit node.

At step 670, upon receiving the first reserve request message, the transit node generates and updates state information associated with the temporal LSP in a local LSP DB according to the first reserve request message. The transit node allocates a second label for the temporal LSP. The transit node retrieves the stored information (e.g., constraint and scheduled time intervals) of the first path request message received at step 630. The transit node reserves resource on the next hop link from the transit node to the egress node according to the constraints for every scheduled time interval. The transit node writes a forwarding entry for the temporal LSP in a local FIB according to the allocated second label and the first label received in the first reserve request message to facilitate subsequent data forwarding to the egress node. The transit node updates the first reserve message, for example, to include the second label, to produce a second reserve request message. At step 680, the transit node sends the second reserve message to the ingress node.

At step 690, upon receiving the second reserve request message, the ingress node reserves resource on the next hop link from the ingress node to the transit node according to the constraints for every scheduled time interval and writes a forwarding entry for the temporal LSP in a local FIB according to the second label received in the second reserve request message to facilitate subsequent data forwarding to the transit node. It should be noted that, in some embodiments, each of the ingress node, the transit node, and the egress node maintains a time-based TEDB to track resources on connected links in a time-basis and updates other nodes in the network of available resource on the connected links after an allocation, for example, by employing an open shortest path first (OSPF) protocol. In another embodiment, upon receiving a path request message in a step such as step 630, a transit node or an ingress node determines that a next hop link to the next hop node satisfies the constraints in every time interval of the time schedule and reserves resource on the next hop link according to the constraints for every scheduled time interval. Upon receiving the reserve request message corresponding to the path request message in a step such as step 670, the transit node or the ingress node does not reserve resource on the next hop link.

FIG. 7 is a protocol diagram of an embodiment of a method 700 of deleting a temporal LSP such as the temporal LSP 150. The method 700 is implemented between an ingress node, a transit node, and an egress node of a temporal LSP in a network such as the network 100. The ingress node is similar to the edge node PE1 121, the transit node is similar to the internal node P1 and P2 122, and the egress node is similar to the edge node PE4 121. The method 700 is implemented after a temporal LSP is established from the ingress node to the egress node and through the transit node by employing the method 600, where resources are reserved in advanced on links such as the links 130-133 along a path of the temporal LSP. At step 710, the ingress node receives a command from a user or a network administrator to tear down the temporal LSP. The ingress node generates a first path teardown message according to the command. For example, the first path teardown message indicates a node sequence of the path of the temporal LSP. The ingress node sends the first path teardown message to itself to initiate the tear down of the temporal LSP. Upon receiving the first teardown message, the ingress node releases the resource previously reserved for the temporal LSP on a next-hop link to the transit node. For example, bandwidth is reserved on the next-hop link for a series of time intervals and some of the intervals have not elapsed. Thus, the ingress node releases bandwidth on the next-hop link for the remaining time intervals. After releasing the resource, the ingress node removes the forwarding entry and other associated states for the temporal LSP. The ingress node updates the first path teardown message to produce a second path teardown message. For example, the ingress node removes reference of the ingress node itself from the node sequence. At step 720, the ingress node sends the second path teardown message to the transit node, which is the next-hop node along on the path of the temporal LSP.

At step 730, upon receiving the second path teardown message, the transit node processes the second path teardown message to obtain a next hop link on the path of the temporal LSP. The transit node releases the resource previously reserved for the temporal LSP on the next-hop link to the egress node. The resource is released for every remaining scheduled time interval. After releasing the resource, the transit node releases the label previously allocated for the temporal LSP and removes the forwarding entry and other associated states for the temporal LSP. The transit node updates the second path teardown message to produce a third path teardown message. At step 740, the transit node sends the third path teardown message to the egress node, which is the next-hop node on the path of the temporal LSP.

At step 750, upon receiving the third path teardown message, the egress node releases the label previously allocated for the LSP and removes the forwarding entry and states associated with the temporal LSP. It should be noted that, in some embodiments, the method 700 is implemented after a temporal LSP is partially established from the ingress node to the egress node by employing the method 600 and the ingress node receives a PathErr message for the temporal LSP.

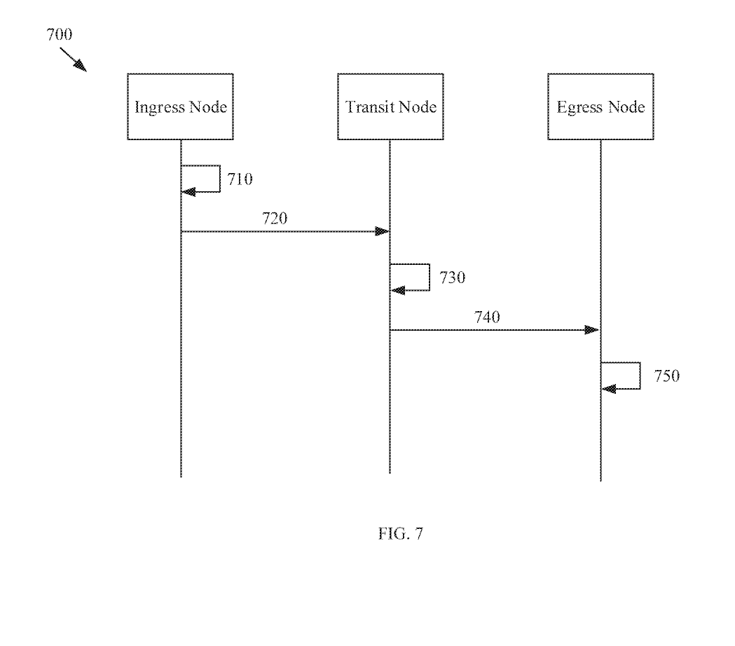

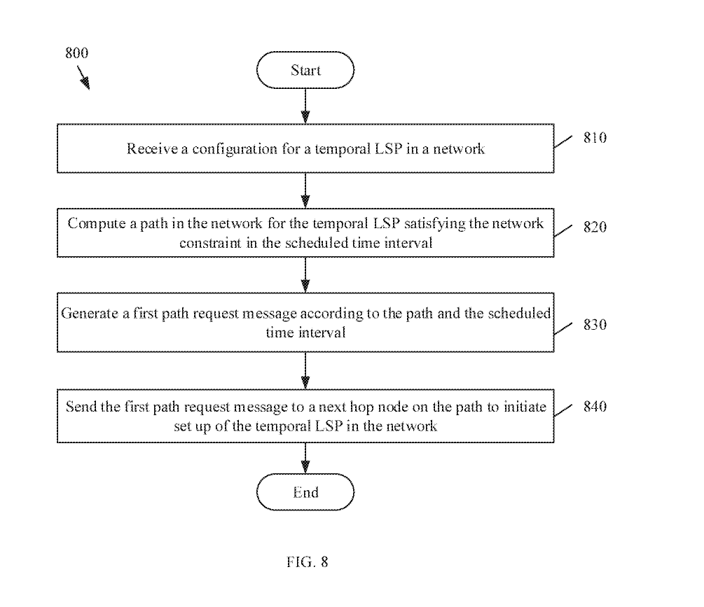

FIG. 8 is a flowchart of an embodiment of a method 800 of creating a temporal LSP such as the temporal LSP 150 in a network such as the network 100. The method 800 is implemented by an NE such as the NE 200 and the edge nodes 121 when the NE functions as an ingress node of the temporal LSP. The method 800 is similar to the method 600. The method 800 is implemented when the ingress node receives a configuration for the temporal LSP. At step 810, a configuration for a temporal LSP in a network is received, for example, from a user or a network administrator. The configuration indicates a network constraint and a time interval similar to the time intervals 320, 420, and 520 scheduled for the temporal LSP to carry traffic. The time interval begins at a predetermined start time and ends at a predetermined end time. At step 820, a path in the network is computed for the temporal LSP satisfying the network constraint in the scheduled time interval. For example, the path is computed by employing a constrained shortest path first (CSPF) algorithm. At step 830, a first path request message is generated according to the path and the scheduled time interval. The first path request message may be an extended RSVP-TE PATIH message, as described more fully below. The first path request message indicates a node sequence on the path, the predetermined start time, and the predetermined end time. The predetermined start time and the predetermined end time may be in a format of absolute time and/or relative time. At step 840, the first path request message is sent to a next hop node on the path to initiate set up of the temporal LSP in the network. It should be noted that the method 800 is also suitable for use with a recurrent time schedule similar to the schedule shown in the scheme 400 or with an elastic time schedule similar to the schedule shown in the scheme 500.

FIG. 9 is a flowchart of another embodiment of a method 900 of creating a temporal LSP such as the temporal LSP 150 in a network such as the network 100. The method 900 is implemented by an NE such as the NE 200, the edge nodes 121, and the internal nodes 122 that are ingress nodes such as the edge node PE1 121 or a transit node such as the internal nodes P1 and P2 122 on a path of the temporal LSP. The method 900 is similar to the method 600. The method 900 is implemented when the NE receives a path request message for a temporal LSP. For example, an ingress node of the temporal LSP computed a path for the temporal LSP and initiated creation of the temporal LSP by employing the method 800. At step 910, a first path request message requesting creation of a first temporal LSP in a network is received. The first path request message indicates a network constraint, a path, and scheduled time interval having a predetermined start time and a predetermined end time for the first temporal LSP to carry first traffic. The path includes a sequence of nodes. A node sequence for the temporal LSP 150 may be represented as the edge node PE1 121, the internal node P1 122, the internal node P2 122, and the edge node PE4 121. The node sequence may be updated to exclude nodes prior to a next hop node as a path request is propagated downstream. When the NE is an ingress node of the first temporal LSP, the first path request message is sent by the NE itself. When the NE is a transit node, the first path request message is sent by a next upstream node on the path. At step 920, information of the first path request message is stored, for example, in a memory device such as the memory device 232.

At step 930, a determination is made whether a next hop link to a next downstream node on the path comprises a sufficient amount of network resource in the scheduled time interval to satisfy the network constraint. When determining that the next hop link comprises an insufficient amount of network resource, the method 900 proceeds to step 940. At step 940, a path error message is sent to a sender of the first path request message.

When determining that the next hop link comprises a sufficient amount of network resource, the method 900 proceeds to step 950. At step 950, a second path request message is generated according to the first path request message. For example, the NE removes reference to the NE from the sequence of nodes on the path when generating the second path request message. At step 955, the second path request message is sent to a next downstream node on the path.

At step 960, a first reserve request message is received from the next downstream node requesting an in-advance reservation of the network resource for the first temporal LSP. The first reserve request message indicates a first label. At step 965, a network resource is reserved on a next hop link to the next downstream node for use during the scheduled time interval for the temporal LSP according to the information stored at step 920. The network resource is reserved from the predetermined start time to the predetermined end time in advance of the predetermined start time. In an embodiment, after allocating the network resource in advance in the scheduled time interval, the NE may distribute a network resource update about the next hop link to other NEs in the network, where the update indicates remaining available network resource in the scheduled time interval. At step 970, a second label is allocated for the first temporal LSP. At step 975, a forwarding entry is generated according to the second label and the first label. At step 980, a second reserve request message is generated according to the first reserve request message and the second label. At step 985, the second reserve request message is sent to a next upstream node. The first reserve request message and the second reserve request message may be RSVP-TE RESV message, and the path error message may a RSVP-TE path error (PATHERR) message. It should be noted that the method 900 is also suitable for use with a recurrent time schedule similar to the schedule shown in the scheme 400 or with an elastic time schedule similar to the schedule shown in the scheme 500.

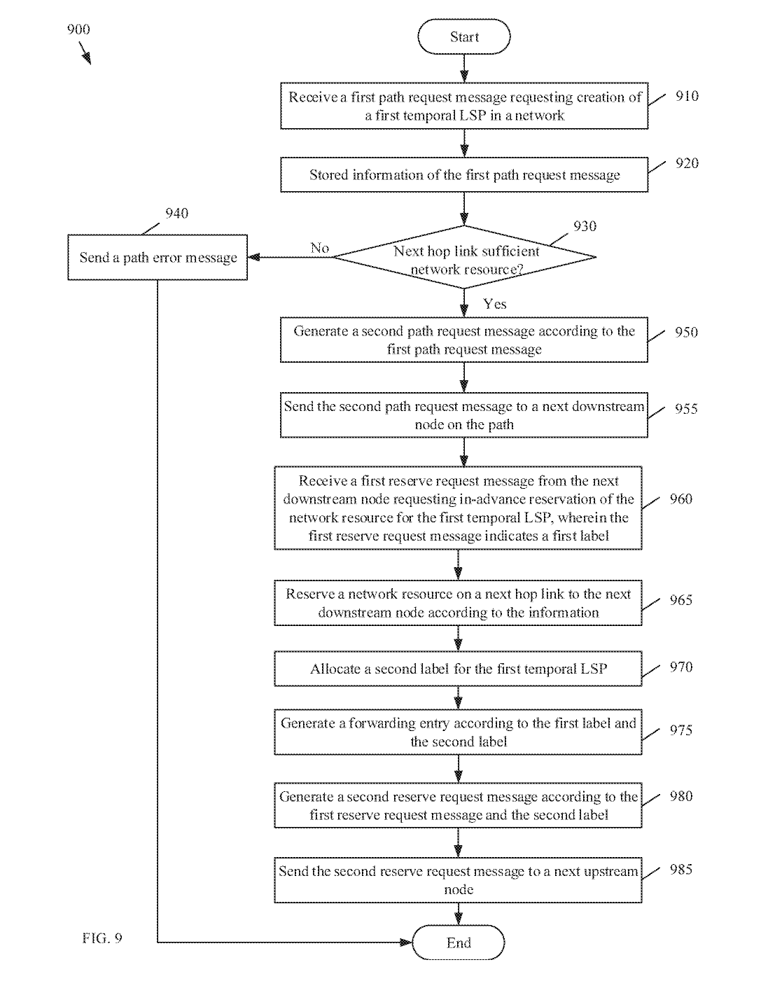

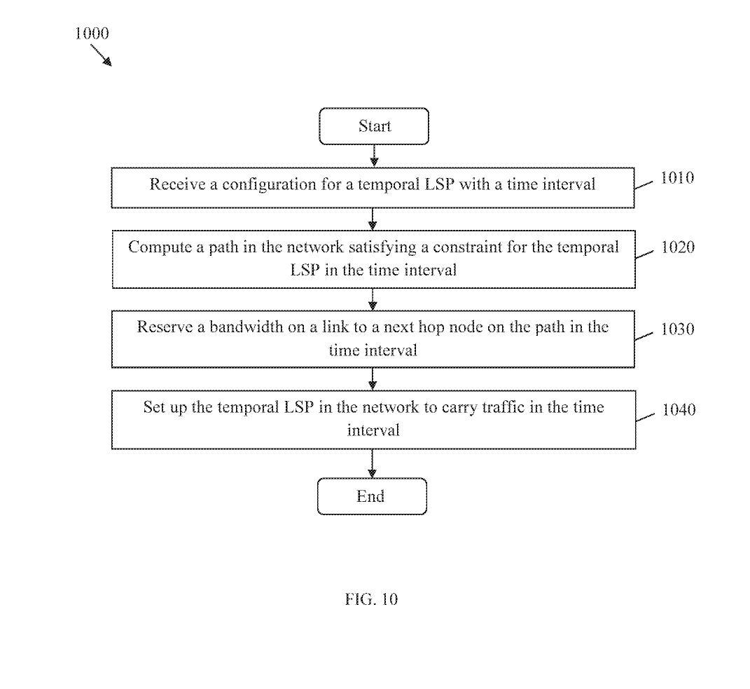

FIG. 10 is a flowchart of another embodiment of a method 1000 of creating a temporal LSP such as the temporal LSP 150 in a network such as the network 100. The method 1000 is implemented by an NE such as the NE 200 and the edge nodes 121 when the NE functions as an ingress node of the temporal LSP. The method 1000 is similar to the methods 600, 800, and 900. The method 1000 is implemented when the ingress node receives a configuration for the temporal LSP. At step 1010, a configuration for a temporal LSP with a time interval such as the time intervals 320, 420, and 520 is received. At step 1020, a path in the network satisfying a constraint for the temporal LSP in the time interval is computed. At step 1030, a bandwidth is reserved on a link such as the links 130-133 to a next hop node on the path in the time interval. At step 1040, the temporal LSP in the network is set up to carry traffic in the time interval, for example, by sending a path request message to a next downstream node on the path to request creation of the temporal LSP.

FIG. 11 is a flowchart of an embodiment of a method of deleting a temporal LSP such as the temporal LSP 150 in a network such as the network 100. The method 1100 is implemented by an NE such as the NE 200, the edge nodes 121, and the internal nodes 122 that are an ingress node or a transit node on a path of the temporal LSP. The method 1100 is similar to the method 700. The method 1100 is implemented after creating a temporal LSP by employing the methods 600, 800, 900, and 1000. For example, information associated with the temporal LSP and a forwarding entry for the temporal LSP are stored in memory such as the memory device. The information may include time intervals at which a network resource is reserved in advance for the temporal LSP. At step 1110, a path teardown message requesting deletion of the temporal LSP is received. The path teardown message indicates a node sequence of a path of the temporal LSP. When the NE is an ingress node of the temporal LSP, the first path request message is sent by the NE itself. When the NE is a transit node, the first path request message is sent by a next upstream node on the path. At step 1120, information associated with the temporal LSP is retrieved from the memory. At 1130, the network resource reserved in advance for the temporal LSP on a next hop link to a next downstream node is released for the remaining time intervals. At step 1140, the forwarding entry associated with the temporal LSP is deleted. At step 1150, a second path teardown message is generated according to the first teardown message. For example, the second teardown message excludes the NE from a node sequence of the path. At step 1160, the second teardown message is sent to the next downstream node.

In an embodiment, the RSVP-TE protocol is extended to support creation of temporal LSPs such as the LSP 150 as described in the methods 600, 800, 900, and 1000. For example, the RSVP-TE PATH message is extended indicate scheduling or timing information of a temporal LSP as shown below:

<Path Message>::=<Common Header>[<INTEGRITY>]
[[<MESSAGE_ID_ACK>|<MESSAGE_ID_NACK>] . . . ]
[<MESSAGE_ID>]<SESSION><RSVP_HOP><TIME_VALUES>
[<EXPLICIT_ROUTE>]
<LABEL_REQUEST>[<PROTECTION>][<LABEL_SET> . . . ]
[<SESSION_ATTRIBUTE>][<NOTIFY_REQUEST>]
[<ADMIN_STATUS>][<POLICY_DATA> . . . ]
<sender descriptor>[<S2L sub-LSP descriptor list>]
[<time interval list>]

As shown above, the extended RSVP-TE PATH message includes similar message objects as described in the RFC 3209. However, the time-interval object, <time interval list> is added to indicate an LSP schedule. The content and format of the time-interval object is described more fully below.

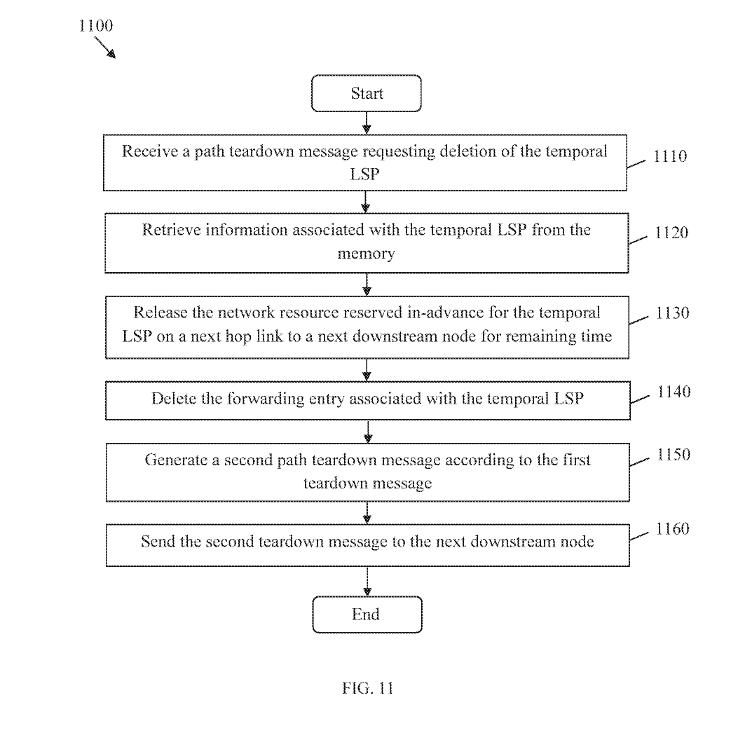

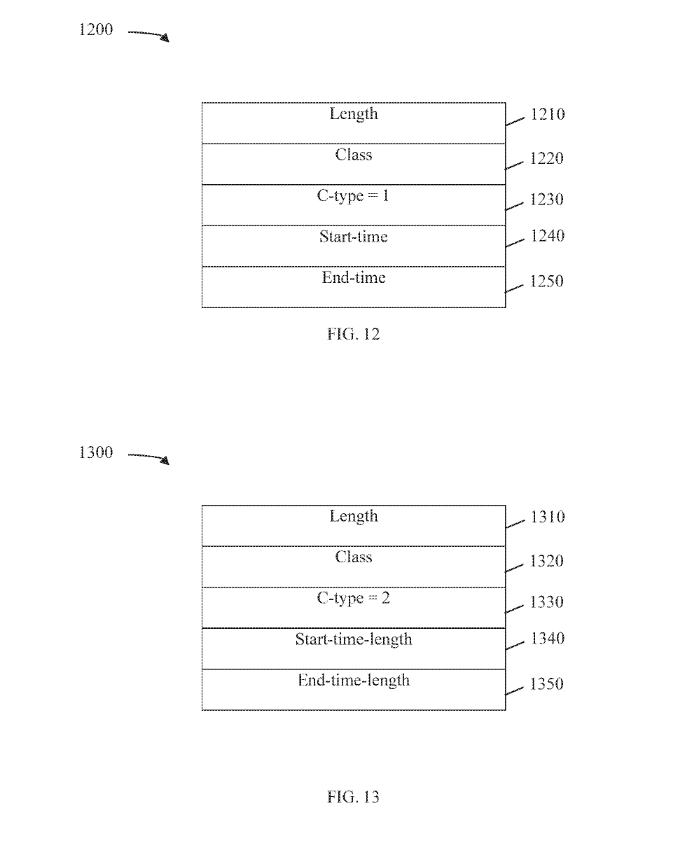

FIGS. 12-17 illustrate various embodiments for extending the RSVP-TE protocol to facilitate creation and deletion of temporal LSPs such as the temporal LSP 150. The extension is similar to the extension described in IETF draft document draft-chen-teas-rsvp-tts-00.txt titled, “Extensions to MPLS for Temporal LSP.” published in Jul. 3, 2015 by H. Chen. et al., which is incorporated by reference. FIG. 12 is a schematic diagram illustrating an embodiment of an absolute time interval object 1200. The absolute time interval object 1200 is employed by an NE such as the edge nodes 121, the internal nodes 122, and the NE 200 in a network such as the network 100 to indicate a time interval such as the time intervals 320, 420, and 520 scheduled for a temporal LSP such as the LSP 150 to carry traffic. The absolute time interval object 1200 is included in a RSVP-TE PATH message. The RSVP-TE PATH message is described in the document RFC 3209. The absolute time interval object 1200 comprises a length field 1210, a Class field 1220, a C-type field 1230, a Start-time field 1240, and an End-time field 1250. The length field 1210 is about two octets long and indicates a length of the absolute time interval object 1200. The Class field 1220 is about one octet long and indicates that the absolute time interval object 1200 is a time-interval object. The C-type field 1230 is about one octet long and indicates an object type. For example, the C-type field 1230 is set to a value of 1 for an absolute time interval object 1200. The Start-time field 1240 is about four octets long and indicates an absolute time when an LSP is scheduled to start carrying traffic. The End-time field 1250 is about four octets long and indicates an absolute time when the LSP is scheduled to stop carrying traffic.

FIG. 13 is a schematic diagram illustrating an embodiment of a relative time interval object 1300. The relative time interval object 1300 is employed by an NE such as the edge nodes 121, the internal nodes 122, and the NE 200 in a network such as the network 100 to indicate a time interval such as the time intervals 320, 420, and 520 scheduled for a temporal LSP such as the LSP 150 to carry traffic. The relative time interval object 1300 is included in a RSVP-TE PATH message. The relative time interval object 1300 comprises a length field 1310, a Class field 1320, a C-type field 1330, a Start-time-length field 1340, and an End-time-length field 1350. The length field 1310 is about two octets long and indicates a length of the relative time interval object 1300. The Class field 1320 is similar to the Class field 1220. The C-type field 1330 is similar to the C-type field 1230. For example, the C-type field 1330 is set to a value of 2 for a relative time interval object 1300. The Start-time-length field 1340 is about four octets long and indicates a time duration in some time units such as seconds from a current local time to a time that an LSP starts to carry traffic. The End-time-length field 1350 is about four octets long and indicates a time duration in some time units such as seconds from a current local time to a time that the LSP stops carrying traffic.

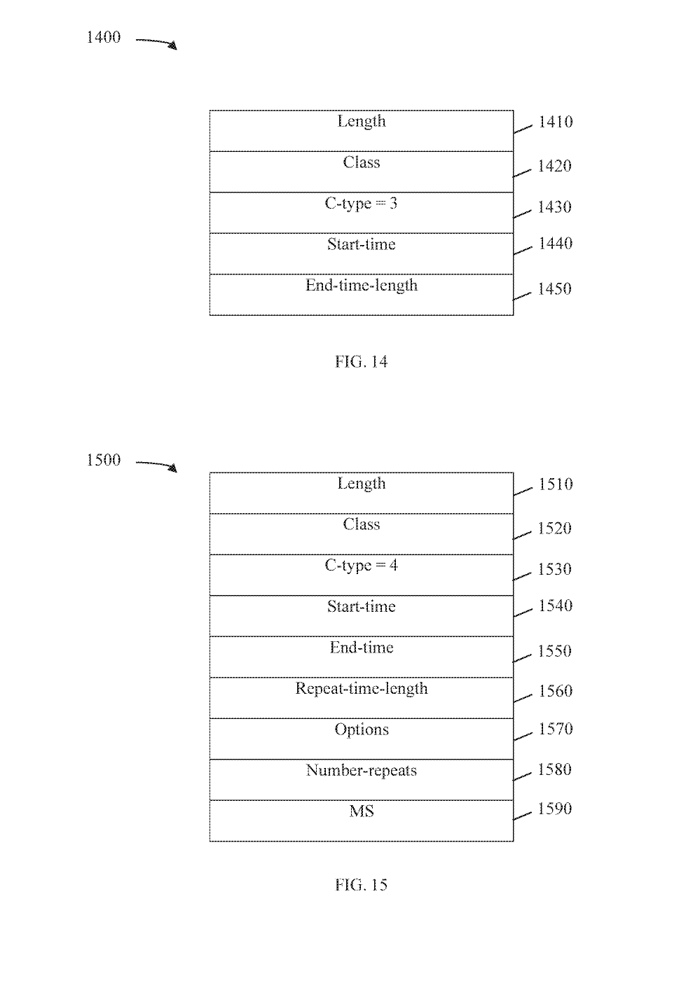

FIG. 14 is a schematic diagram illustrating an embodiment of a combined time interval object 1400. The combined time interval object 1400 is employed by an NE such as the edge nodes 121, the internal nodes 122, and the NE 200 in a network such as the network 100 to indicate a time interval such as the time intervals 320, 420, and 520 scheduled for a temporal LSP such as the LSP 150 to carry traffic. The combined time interval object 1400 is included in a RSVP-TE PATH message. The combined time interval object 1400 comprises a length field 1410, a Class field 1420, a C-type field 1430, a Start-time field 1440, and an End-time-length field 1450. The length field 1410 is about two octets long and indicates a length of combined time interval object 1400. The Class field 1420 is similar to the Class fields 1220 and 1320. The C-type field 1430 is similar to the C-type fields 1230 and 1330. For example, the C-type field 1430 is set to a value of 3 for a combined time interval object 1400. The Start-time field 1440 is similar to the Start-time field 1240. The End-time-length field 1450 is similar to the End-time-length field 1350.

FIG. 15 is a schematic diagram illustrating an embodiment of a recurrent absolute time interval object 1500. The recurrent absolute time interval object 1500 is employed by an NE such as the edge nodes 121, the internal nodes 122, and the NE 200 in a network such as the network 100 to indicate a time interval such as the time intervals 320, 420, and 520 scheduled for a temporal LSP such as the LSP 150 to carry traffic. The recurrent absolute time interval object 1500 is included in a RSVP-TE PATH message. The recurrent absolute time interval object 1500 comprises a length field 1510, a Class field 1520, a C-type field 1530, a Start-time field 1540, an End-time field 1550, a Repeat-time-length field 1560, an Options field 1570, a Number-Repeat field 1580, and a millisecond (MS) field 1590. The length field 1510 is about two octets long and indicates a length of recurrent absolute time interval object 1500. The Class field 1520 is similar to the Class fields 1220, 1320, and 1420. The C-type field 1530 is similar to the C-type fields 1230, 1330, and 1430. For example, the C-type field 1530 is set to a value of 4 for a recurrent absolute time interval object 1500. The Start-time field 1540 is similar to the Start-time fields 1240 and 1440. The End-time-length field 1550 is similar to the End-time fields 1250.

The Repeat-time-length field 1560 is about four octets long and indicates a time duration in seconds between the start of each time intervals at which an LSP is scheduled for carrying to traffic. The Options field 1570 is about one octet long and indicates a repeat duration. For example, the Options field 1570 may be set to a value of 1 to indicate a per day repeat cycle. The Options field 1570 may be set to a value of 2 to indicate a per week repeat cycle. The Options field 1570 may be set to a value of 3 to indicate a per month repeat cycle. The Options field 1570 may be set to a value of 4 to indicate a per year repeat cycle. The Options field 1570 may be set to a value of 5 to indicate a repeat cycle according to the Repeat-Time-Length field 1560. The Number-repeats field 1580 is about three octets long and indicates a number of repeats for the scheduled time interval. It should be noted that the Repeat-time-length field 1560 is valid when the Options field 1570 is set to a value of 5. The MS field is about one octet long and indicates a time extension for extending the duration indicated in the Repeat-time-length field 1560 in milliseconds.

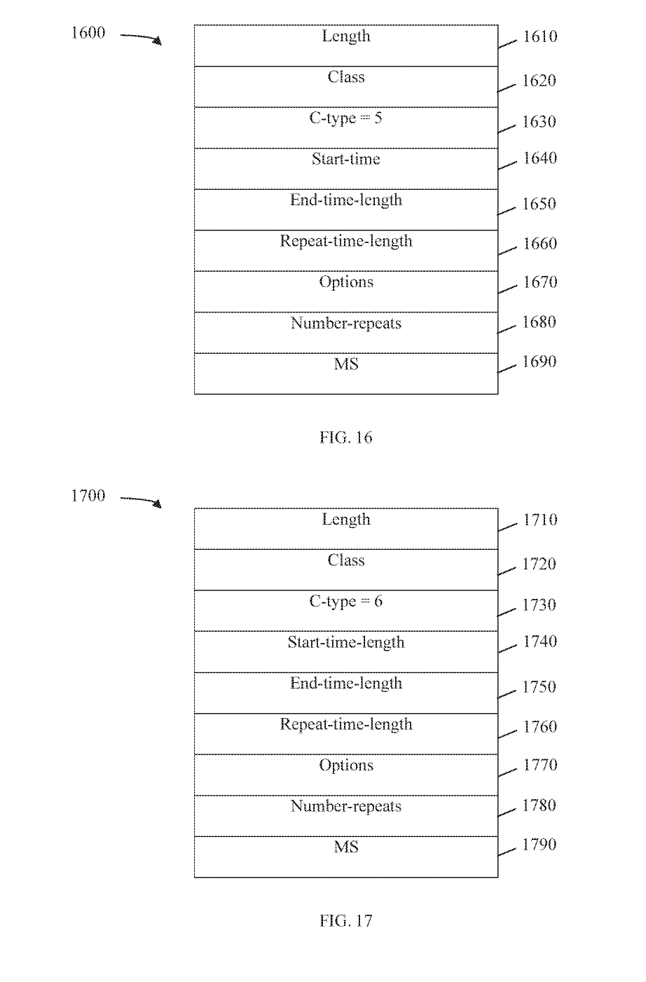

FIG. 16 is a schematic diagram illustrating an embodiment of a recurrent combined time interval object 1600. The recurrent combined time interval object 1600 is employed by an NE such as the edge nodes 121, the internal nodes 122, and the NE 200 in a network such as the network 100 to indicate a time interval such as the time intervals 320, 420, and 520 scheduled for a temporal LSP such as the LSP 150 to carry traffic. The recurrent combined time interval object 1600 is included in a RSVP-TE PATH message. The recurrent combined time interval object 1600 comprises a length field 1610, a Class field 1620, a C-type field 1630, a Start-time field 1640, an End-time-length field 1650, a Repeat-time-length field 1660, an Options field 1670, a Number-Repeat field 1680, and an MS field 1690. The length field 1610 is about two octets long and indicates a length of the recurrent combined time interval object 1600. The Class field 1620 is similar to the Class fields 1220, 1320, 1420, and 1520. The C-type field 1630 is similar to the C-type fields 1230, 1330, 1430, and 1530. For example, the C-type field 1630 is set to a value of 5 for a recurrent combined time interval object 1600. The Start-time field 1640 is similar to the Start-time fields 1240, 1440, and 1540. The End-time-length field 1650 is similar to the End-time-length fields 1350 and 1450. The Repeat-time-length field 1660 is similar to the Repeat-time-length field 1560. The Options field 1670 is similar to the Options field 1570. The Number-repeats field 1680 is similar to the Number-repeats field 1580. The MS field 1690 is similar to the MS field 1590.

FIG. 17 is a schematic diagram illustrating an embodiment of a recurrent relative time interval object 1700. The recurrent relative time interval object 1700 is employed by an NE such as the edge nodes 121, the internal nodes 122, and the NE 200 in a network such as the network 100 to indicate a time interval such as the time intervals 320, 420, and 520 scheduled for a temporal LSP such as the LSP 150 to carry traffic. The recurrent relative time interval object 1700 is included in a RSVP-TE PATH message. The recurrent relative time interval object 1700 comprises a length field 1710, a Class field 1720, a C-type field 1730, a Start-time-length field 1740, an End-time-length field 1750, a Repeat-time-length field 1760, an Options field 1770, a Number-Repeat field 1780, and an MS field 1790. The length field 1710 is about two octets long and indicates a length of the recurrent relative time interval object 1700. The Class field 1720 is similar to the Class fields 1220, 1320, 1420, and 1520. The C-type field 1730 is similar to the C-type fields 1230, 1330, 1430, 1530, and 1630. For example, the C-type field 1730 is set to a value of 6 for a recurrent relative time interval object 1700. The Start-time-length field 1740 is similar to the Start-time-length field 1340. The End-time-length field 1750 is similar to the End-time-length fields 1350, 1450, and 1650. The Repeat-time-length field 1760 is similar to the Repeat-time-length fields 1560 and 1660. The Options field 1770 is similar to the Options fields 1570 and 1670. The Number-repeats field 1780 is similar to the Number-repeats fields 1580 and 1680. The MS field 1790 is similar to the MS fields 1590 and 1690.

As described above, once an existing MPLS TE LSP is set up, it is assumed to carry traffic forever, until it is taken down. When an MPLS TE LSP tunnel is put up, it is assumed that the LSP consumes its reserved network resources forever, even though the LSP may only use network resources during some period of time. As a result, the network resources are not used efficiently. Moreover, a tunnel service may not be reserved or booked in advance in a period of time. This disclosure specifies extensions to RSVP-TE for creating and maintaining an MPLS TE LSP in a period of time called a time interval or a sequence of time intervals. It is assumed that the LSP carries traffic during this time interval or each of these time intervals. Thus, network resources are efficiently used. More importantly, some new services may be provided. For example, a consumer may book a tunnel service in advance for a given time interval. Tunnel services may be scheduled as requested.

In an embodiment, a few architectural components are extended to support temporal LSPs. These components include OSPF. CSPF and RSVP-TE. OSPF is extended to distribute and maintain TE information for a link (e.g., the links 130-133) in a sequence of time intervals (e.g., the time intervals 320, 420, and 520). CSPF is extended to compute a path for a temporal LSP based on the TEDB containing TE information for every link in a sequence of time intervals. RSVP-TE is extended to create a temporal LSP and maintain the status of the temporal LSP.

In an embodiment, a user configures the ingress node of a temporal LSP with a time interval or a sequence of time intervals. A simple time interval is a time interval from start time Ta to end time Tb, which may be represented as [Ta, Tb]. When an LSP is configured with time interval [Ta, Tb], a path satisfying the constraints for the LSP in the time interval is computed and the LSP along the path is set up to carry traffic from Ta to Tb. For a time interval from a start time Ta to an infinite end time, it may be represented as [Ta, INFINITE]. In addition to simple time intervals, there are recurrent time intervals and elastic time intervals.

A recurrent time interval represents a series of repeated simple time intervals. It has a simple time interval such as [Ta. Tb], a number of repeats such as 10 (repeats 10 times), and a repeat cycle/time such as a week (repeats every week). Recurrent time interval “[Ta, Tb] repeats n times with repeat cycle C” represents n+1 simple time intervals as follows:

[Ta,Tb],[Ta+C,Tb+C],[Ta+2C,Tb+2C], . . . ,[Ta+nC,Tb+nC]

When a LSP is configured with a recurrent time interval such as “[Ta, Tb] repeats 10 times with a repeat cycle a week.” a path satisfying the constraints for the LSP in each of the simple time intervals (such as 11 simple time intervals) represented by the recurrent time interval is computed and the LSP along the path is set up to carry traffic in each of the simple time intervals.

An elastic time interval represents a time period with an elastic range. It has a simple time interval such as [Ta, Tb] with an elastic range such as within −P and Q. Elastic time interval “[Ta, Tb] within −P and Q” means a time period from (Ta+X) to (Tb+X), where −P<=X<=Q, P and Q is an amount of time, such as 600 seconds. When an LSP is configured with an elastic time interval such as “[Ta,Tb] within −P and Q.” a path is computed such that the path satisfies the constraints for the LSP in the time period from (Ta+X) to (Tb+X) and |X| is the minimum value from −P to Q. That is that [Ta+X, Tb+X] is the time interval closest to [Ta, Th] within the elastic range. The LSP along the path is set up to carry traffic in the time period from (Ta+X) to (Tb+X).

TIME-INTERVAL objects are the internal representations of time intervals. A Class-Num for the objects is to be assigned by Internet assigned number association (IANA). An absolute TIME-INTERVAL object (e.g., the absolute time interval object 1200) comprises a Start-time and an End-time, representing time interval [Start-time, End-time]. All bits in End-time field set to one represents INFINITE. Both of these two times are the times that are synchronized among all network nodes. Thus the clocks on all the nodes are synchronized if an absolute TIME-INTERVAL object is used. The time period represented in an absolute TIME-INTERVAL object is more accurate.

A relative TIME-INTERVAL object (e.g., the relative time-interval object 1300) comprises a Start-time-length and an End-time-length, which represents time interval below:

[current-time+Start-time-length,current-time+End-time-length]

where current-time is the current local time on a node. All bits in End-time-length field set to one represents INFINITE.

When a time interval from time Ta to time Th is configured on a node, these two time lengths are the time lengths that are computed on the node using the current local time as follows.

Start-time-length=Ta−current-time,

End-time-length=Tb−current-time.

For a relative TIME-INTERVAL object, the clocks/times on all the nodes may be different.

A recurrent absolute TIME-INTERVAL, object (e.g., the recurrent absolute time-interval object 1500), its body contains a Start-time, an End-time, a Repeat-time-length, an Options field, and a Number-repeats field. The Start-time and End-time represent a time interval [Start-time. End-time]. The Repeat-time-length represents a repeat cycle/time, which is valid if the Options field is set to indicate the way to repeat is “repeat every Repeat-time-length.” The Options field indicates a way to repeat. The Number-repeats indicates the number of repeats of time interval [Start-time. End-time].
Start-time: The time LSP starts to carry traffic,
End-time: The time LSP ends carrying traffic,
Repeat-time-length: The time length in seconds after which LSP starts to carry traffic again for (End-time−Start-time),
Options: Indicates a way to repeat,
Options=1: repeat every day,
Options=2: repeat every week.
Options=3: repeat every month,
Options=4: repeat every year,
Options=5: repeat every Repeat-time-length,
Number-repeats: The number of repeats. In each of the repeats. LSP carries traffic.

A recurrent relative TIME-INTERVAL object (e.g., the recurrent relative time-interval object 1700) comprises a Start-time-length, an End-time-length, a Repeat-time-length, an Options field, and a Number-repeats field. The Start-time-length and End-time-length represents a time interval:

[current-time+Start-time-length,current-time+End-time-length]

where current-time is a current local time.

The Repeat-time-length represents a repeat cycle/time, which is valid if the Options field is set to indicate the way to repeat is “repeat every Repeat-time-length.” The Options field indicates a way to repeat. The Number-repeats indicates the number of repeats of the time interval above.
Start-time-length: The time length in seconds from a current local time to the time LSP starts to carry traffic.
End-time-length: The time length in seconds from a current local time to the time LSP ends carrying traffic,
Repeat-time-length: The time length in seconds after which LSP starts to carry traffic again for (End-time-length−Start-time-length),
Options: Indicates a way to repeat,
Options=1: repeat every day,
Options=2: repeat every week,
Options=3: repeat every month.
Options=4: repeat every year.
Options=5: repeat every Repeat-time-length,
Number-repeats: The number of repeats. In each of the repeats, LSP carries traffic.

A Path message is enhanced to carry the information about a time interval or a sequence of time intervals through including a time interval list. The format of the message is illustrated below

```
<Path Message> ::= <Common Header> [ <INTEGRITY> ]
    [ [<MESSAGE_ID_ACK> | <MESSAGE_ID_NACK>] ...]
    [ <MESSAGE_ID> ]<SESSION> <RSVP_HOP>
    <TIME_VALUES>
    [ <EXPLICIT_ROUTE> ]
    <LABEL_REQUEST> [ <PROTECTION> ] [ <LABEL_SET> ...]
    [ <SESSION_ATTRIBUTE> ] [ <NOTIFY_REQUEST> ]
    [ <ADMIN_STATUS> ] [ <POLICY_DATA> ... ]
    <sender descriptor> [<S2L sub-LSP descriptor list>]
    [<time interval list>]
```

The time interval list in the message is defined below. It is a sequence of TIME-INTERVAL objects, each of which describes a time interval or a series of time intervals.

```
<time interval list> ::=
        <time interval descriptor>
        [ <time interval list> ]
  <time interval descriptor> ::= <TIME-INTERVAL>
```

To set up a temporal LSP, the ingress of the LSP includes the TIME-INTERVAL objects representing the time intervals configured for the LSP in the PATH message for the LSP. In addition, the ingress computes a shortest path satisfying the constraints for the LSP in each of the time intervals. It may include the explicit routing object (ERO) for the path in the PATH message for the LSP. For every node along the path for the LSP, when receiving a PATH message with TIME-INTERVAL objects, it obtains the time intervals represented by the objects in the message received and forwards the objects unchanged to the next hop if there is one. It adds the time intervals into the state for the LSP and checks whether there is enough bandwidth in each of the time intervals. If there is, it reserved the bandwidth on the link to the next hop (if there is a next hop) in each of the time intervals. If there is not, a PathErr message is returned.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. An ingress node in a network, comprising:
a receiver configured to receive a first request for a temporal label switched path (LSP) in the network, wherein the first request indicates a network constraint and a scheduled time interval having a predetermined start time and a predetermined end time for the temporal LSP to carry traffic;
a processor coupled to the receiver and configured to:
compute a path in the network for the temporal LSP, wherein the path satisfies the network constraint in the scheduled time interval; and
reserve a network resource for use during the scheduled time interval for the temporal LSP in advance of the predetermined start time, wherein the network resource is reserved on a link extending from the ingress node to a next hop node on the path; and
a transmitter coupled to the processor and configured to send a path request message to the next hop node to initiate set up of the temporal LSP in the network.

2. The ingress node of claim 1, wherein reserving the network resource does not include a reservation for the network resource at a current time, and wherein the network resource is reserved from a time-based traffic engineering link state database (TEDB).

3. The ingress node of claim 1, wherein the scheduled time interval is a recurrent time interval, and wherein the path request message further indicates a repeat period that the scheduled time interval repeats and a number of repeats for the scheduled time interval.

4. The ingress node of claim 1, wherein the first request further indicates a desired start time and an elastic time range for the scheduled time interval, wherein the processor is further configured to compute the path for the temporal LSP by determining a minimum amount of time to shift the scheduled time interval from the desired start time such that the shifted scheduled time interval satisfies the network constraint and is temporally positioned within the elastic time range, and wherein the path request message indicates the shifted scheduled time interval.

5. The ingress node of claim 1, wherein the transmitter is further configured to distribute, in the network, an update of remaining available network resources on the link in the scheduled time interval after the network resource is reserved on the link.

6. The ingress node of claim 1, wherein the receiver is further configured to receive a reserve request message from the next hop node subsequent to sending the path request message, wherein the reserve request message requests an in-advance reservation of the network resource for the temporal LSP from the predetermined start time to the predetermined end time, and wherein the network resource is reserved in response to the reserve request message.

7. The ingress node of claim 1, wherein the receiver is further configured to receive a second request to tear down the temporal LSP, wherein the processor is further configured to release the network resource reserved in advance on the link in remaining time of the scheduled time interval, and wherein the transmitter is further configured to send a path tear down message to the next hop node to initiate the tear down of the temporal LSP in the network.

8. The ingress node of claim 7, wherein the network constraint comprises a bandwidth constraint, a priority constraint, a number of hops constraint, a wavelength constraint, or combinations thereof.

9. A method implemented in a network element (NE), comprising:
receiving, via a receiver of the NE, a first path request message requesting creation of a first temporal label switched path (LSP) in a network, wherein the first path request message indicates a first network constraint, a first path, and a first scheduled time interval having a predetermined start time and a predetermined end time for the first temporal LSP to carry first traffic;
determining, via a processor of the NE, that a first next hop link from the NE to a first next downstream node on the first path comprises a sufficient amount of first network resource in the first scheduled time interval to satisfy the first network constraint; and
reserving, via the processor, the first network resource on the first next hop link for use during the first scheduled time interval for the first temporal LSP in advance of the predetermined start time according to the first network constraint to facilitate data forwarding for the first temporal LSP in the first scheduled time interval.

10. The method of claim 9, further comprising:
generating, via the processor, a second path request message according to the first path request message to indicate the first scheduled time interval; and
sending, via a transmitter of the NE, the second path request message to the first next downstream node to request the creation of the first temporal LSP in the network in the first scheduled time interval.

11. The method of claim 10, wherein the NE is an ingress node of the first temporal LSP, and wherein the method further comprises:
receiving, via the receiver, a configuration for the first temporal LSP indicating the first scheduled time interval and the first network constraint;
computing, via the processor, the first path for the first temporal LSP satisfying the first network constraint in the first scheduled time interval;
generating, via the processor, the first path request message according to the first path computed for the first temporal LSP and the first scheduled time interval received in the configuration; and
sending, via the transmitter, the first path request message to the NE.

12. The method of claim 9, further comprising:
storing, in a memory of the NE, information associated with the first path, the first network constraint, and the first scheduled time interval of the first temporal LSP received in the first path request message, and
receiving, via the receiver, a reserve request message from the first next downstream node requesting in-advance reservation of the first network resource;
wherein the first network resource is reserved in advance on the first next hop link according to the information stored in the memory in response to the reserve request message.

13. The method of claim 12, further comprising storing, in a memory of the NE, a time-based traffic engineering link state database (TEDB), wherein the first network resource is reserved in advance on the first next hop link from the time-based TEDB.

14. The method of claim 11, further comprising:
receiving, via the receiver, a path tear down message requesting deletion of the first temporal LSP; and
releasing, via the processor, the first network resource reserved in advance on the first next hop link in remaining time of the first scheduled time interval.

15. The method of claim 11, further comprising:
receiving, via the receiver, a third path request message from a next upstream node requesting creation of a second temporal LSP in the network, wherein the second path request message indicates a second network constraint, a second path, and a second scheduled time interval for the second temporal LSP to carry second traffic;
determining, via the processor, that a second next hop link to a second next downstream node on the second path comprises an insufficient amount of second network resource in the second scheduled time interval to satisfy the second network constraint; and
sending, via the transmitter, a path error message to the next upstream node indicating a creation error status for the second temporal LSP.

16. A method comprising:
receiving, by an ingress node of a temporal label switched path (LSP) in a network, a configuration for the temporal LSP with a time interval;
computing, by the ingress node, a path in the network satisfying a constraint for the temporal LSP in the time interval;
reserving, by the ingress node, a bandwidth on a link to a next hop node on the path in the time interval; and
setting up, by the ingress node, the temporal LSP in the network to carry traffic in the time interval.

17. The method of claim 16, wherein setting up the temporal LSP in the network further comprises sending, by the ingress node to a next hop node on the path, a resource reservation protocol-traffic engineering (RSVP-TE) path message comprising a time-interval object, wherein the time-interval object comprises:
a Start-Time field indicating a first time that the temporal LSP starts to carry traffic; and
an End-Time field indicating a second time that the temporal LSP ends carrying the traffic;
wherein the first time and the second time are clock times that are synchronized among all network nodes in the network.

18. The method of claim 17, wherein the time interval is a recurrent time interval that the LSP carries the traffic, and wherein the time-interval object further comprises:
a Number-repeats field indicating a number of repeats;
a Repeat-time-length field indicating a repeat-time length in seconds of a repeat cycle for the recurrent time interval; and
an Options field indicating whether the recurrent time interval repeats every day, every week, every month, every year, or repeats every repeat-time length.

19. The method of claim 16, wherein setting up the LSP in the network further comprises sending, by the ingress node to a next hop node on the path, a resource reservation protocol-traffic engineering (RSVP-TE) path message comprising a time-interval object, and wherein the time-interval object comprises:
a Start-time-length field indicating a first time length in seconds from a current local clock time to a first time that the LSP starts to carry traffic; and
an End-time-length field indicating an second time length in seconds from the current local clock time to a second time that the LSP ends carrying the traffic.

20. The method of claim 19, wherein the time interval is a recurrent time interval that the LSP carries the traffic, and wherein the time-interval object further comprises:
a Number-repeats field indicating a number of repeats;
a Repeat-time-length field indicating a repeat-time length in seconds of a repeat cycle for the recurrent time interval; and
an Options field indicating whether the recurrent time interval repeats every day, every week, every month, every year, or repeats every repeat-time length.
